(19) United States
(12) Patent Application Publication
(10) Pub. No.: US 2006/0293071 A1
(43) Pub. Date: Dec. 28, 2006

(54) Document access method

(75) Inventors: Ryan Skraba, Paris (FR); Bruno Legat, Lisses (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/455,155

(22) Filed: Jun. 19, 2006

(30) Foreign Application Priority Data
Jun. 27, 2005 (FR) 0551767

(51) Int. Cl. H04Q 7/20

(52) U.S. Cl. 455/466; 455/566

(57) ABSTRACT

The invention relates to methods of accessing a document linked to a message sent to a mobile terminal via an operator. This is a document access method comprising: a step of an operator sending a mobile first terminal a message linked to a document; a step of a user consulting the message and of displaying on the screen of the mobile first terminal a parameter representing the size of the document; a step of the user employing the man-machine interface of the mobile first terminal to command the operator to associate an address with the document; a step of the user entering the address associated with the document via a man-machine interface of a second terminal having a greater capacity than the mobile first terminal; a step of the operator sending the document to the second terminal; and a step of displaying the document on the screen of the second terminal.

### CROSS-REFERENCE TO RELATED APPLICATIONS

This application is based on French Patent Application No. 0551767 filed 27/06/2005, the disclosure of which is hereby incorporated by reference thereto in its entirety, and the priority of which is hereby claimed under 35 U.S.C. §119.

### BACKGROUND OF THE INVENTION

1. Field of the Invention

The invention relates to methods of accessing a document linked to a message sent to a mobile terminal via an operator. Electronic mail (e-mail) is widely used on large fixed terminals having large capacities. However, unlike SMS (Simple Message Service) and MMS (Multimedia Message Service) messages, electronic mail messages may necessitate resources that exceed the resources available on a small mobile terminal having moderate capacities. Despite the great advances that have been made, an HTML page reproduced on the screen of a mobile terminal, mobile telephone or personal digital assistant (PDA) is still of mediocre quality. Moreover, the capacities of the mobile terminal in terms of bandwidth, memory size and screen size may prove clearly insufficient or necessitate adaptation of the content of the message sent to the mobile terminal before it can be viewed.

2. Description of the Prior Art

In one prior art method, the user employs a fixed terminal that is not his own terminal to configure an electronic mail message in detail, which is time-consuming and irksome.

In a second prior art method, the user employs, on an available fixed terminal that is not his own terminal, certain functions that enable forwarding of messages without the user having to undertake time-consuming and irksome configuration. However, these functions are not always available on the fixed terminal that happens to be available to the user when the message is received, and they are often found deficient in terms of security.

In a third prior art method described in international patent application WO 99/56459 or in US patent application 2002/0094787, for example, rather than the message itself, a URL is systematically sent indicating where the message may be consulted on a fixed terminal having an Internet connection. This prior art method has the drawback that the user cannot sort messages and distinguish between those which, for certain reasons, he wishes to consult on his mobile terminal and those which, for other reasons, he wishes to consult on an available fixed terminal, i.e. a terminal readily accessible to him at his location when he receives the message.

The problem is to enable the user to view quickly on his mobile terminal some messages received on his mobile terminal and to send other messages to an available fixed terminal. The problem arises in particular with documents that are attachments to messages or are integrated into the messages in the form of a hyperlink. The invention proposes to leave the choice to the user. To this end, when a message is linked to a document which might be too large to be viewed correctly on the screen of the mobile terminal, a parameter representing the size of the document is displayed on the screen of the terminal, enabling the user to decide whether or not to associate an address with the document, that decision being reflected either in the terminal sending an operator a command to associate an address with the document or in the direct display of the downloaded document on the screen of the mobile terminal.

### SUMMARY OF THE INVENTION

The invention consists in document access method comprising: a step of an operator sending a mobile first terminal a message linked to a document; a step of a user consulting the message and of displaying on the screen of the mobile first terminal a parameter representing the size of the document; a step of the user employing the man-machine interface of the mobile first terminal to command the operator to associate an address with the document; a step of the user entering the address associated with the document via a man-machine interface of a second terminal having a greater capacity than the mobile first terminal; a step of the operator sending the document to the second terminal; and a step of displaying the document on the screen of the second terminal.

The invention also consists in a mobile terminal specifically adopted to implement the access method of the invention. The invention also consists in a mobile terminal comprising: a receiver adapted to receive from an operator a message linked to a document; a man-machine interface adapted to receive input from a user; a screen adapted to display a parameter representing the size of the document at the command of the man-machine interface and after entry by a user; and a sender adapted to send an operator a command to associate an address with the document following entry by a user at the man-machine interface.

The invention also consists in the telecommunication operator specifically adapted to implement the access method of the invention. The invention also consists in a telecommunication operator comprising: a sender adapted to send a mobile terminal a message linked to a document; a receiver adapted to receive from a mobile terminal a command to associate an address with the document; and a processor adapted to associate an address with the document, wherein: the sender is adapted to send the address associated with the document to a mobile terminal; the receiver is adapted to receive the address associated with the document from a terminal; and the sender is adapted to send the document to a terminal.

The invention will be better understood and other features of the invention and advantages will become apparent in the light of the following description and the appended drawing, which is provided by way of example.

### BRIEF DESCRIPTION OF THE DRAWING

FIG. 1 is a diagram of one example of a system for implementing the access method of the invention comprising a mobile terminal, a fixed terminal and a telecommunication operator.

### DETAILED DESCRIPTION OF THE PREFERRED EMBODIMENT

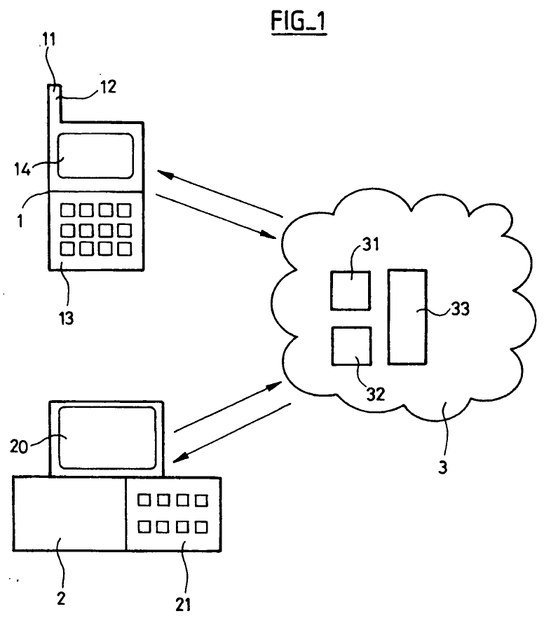

FIG. 1 is a diagram of one example of a system for implementing the access method of the invention comprising a mobile terminal, a fixed terminal and a telecommunication operator. The system comprises a mobile terminal 1, a preferably fixed terminal 2 and a telecommunication operator 3 here symbolized as a telecommunication network. The operator 3 is connected to the mobile terminal 1 and to the fixed terminal 2 via links enabling bidirectional communication symbolized by a double arrow. The operator 3 has a sender 31, a receiver 32 and a processor 33. Just like each of its functional units 31, 32, 33, the operator 3 can use many elements of a telecommunication network. For example, the sender 31 may integrate a plurality of mobile base stations and fixed network access providers. The sender 31 may have elements in common with or be lumped together with the receiver 32. The mobile terminal 1 has a sender 11, a receiver 12, a man-machine interface 13 for input by the user, and a screen 14. The sender 11 may have elements in common with or be lumped together with the receiver 12, for example in the form of an antenna. The preferably fixed terminal 2 includes in particular a screen 20 and a man-machine interface 21 enabling the user to effect input on the terminal 2. The terminal 2 could equally well be a mobile terminal, but in this case it would have to have capacities greater than those of the mobile terminal 1. The sender 31 of the operator 3 can send messages to the receiver 12 of the mobile terminal 1 and to the terminal 2. The receiver 32 can receive messages from the sender 11 of the mobile terminal 1 and from the terminal 2. The man-machine interface 13 of the mobile terminal 1 enables the user to enter commands on the mobile terminal 1. The screen 14 of the mobile terminal 1 and the screen 20 of the terminal 2 can display messages received by the mobile terminal 1 and the terminal 2, respectively. The processor 33 enables the operator to process messages. The terminal 2 considered hereinafter is a fixed terminal, unless otherwise indicated and without prejudice to the general (for example fixed or mobile) character of the terminal 2.

One embodiment of an access method of the invention is described next with reference to FIG. 1. The access method of the invention comprises a plurality of steps. The first step entails the operator 3 sending the mobile terminal 1 a message linked to a document, for example an attachment to the message or a hyperlink included in the message that can be used to access the document. In the next step a user consults the message, a parameter representing the size of the document being displayed on the screen 14 of the mobile terminal 1. The parameter representing the size of the document is either a direct indication of the size of the document, for example, or information indirectly indicating either the size of the document or merely an estimate of the size of the document. At the extreme, merely indicating the document type (text, image or video) may be sufficient for the user to obtain an idea of the size of the document, or it is merely indicated whether the size of the document is above or below a critical size threshold. This parameter is displayed on the screen 14 of the mobile terminal 1 for the user to take note of it and to be in a position to decide if the document can be viewed directly on the screen 14 of the mobile terminal 1 or if he prefers to view the document on the screen of a terminal having greater capacities, for example on the screen 20 of the fixed terminal 2. If he wishes to view the document directly on the screen 14 of the mobile terminal 1, the user may do so directly without using the access method of the invention, but if he wishes to view the document elsewhere, for example on the screen 20 of the fixed terminal 2, the user employs the access method of the invention. In this case, the user commands the operator 3 to associate an address with the document using the man-machine interface 13 of the mobile terminal 1, for example a keypad or a multidirectional lever with a “confirm” button. The command step, and to be more precise the step of input by the user, is preferably effected simply by the user pressing a button or simply by the user clicking on an icon. This input triggers the sending of a command to the operator 3 by the sender 11 of the mobile terminal 1. When the receiver 32 of the operator 3 receives the command, the processor 33 of the operator 3 associates an address, for example a URL, with the document. Thus the user can access the document at that address. To this end the user enters the address associated with the document via the man-machine interface 21 of a second terminal having a greater capacity than the mobile first terminal, for example the fixed terminal 2, which has a greater capacity than the mobile terminal 1 and, of course, a communication link to the operator 3. After the user enters the address on the man-machine interface 21 of the fixed terminal 2, the sender 31 of the operator 3 sends the document to the fixed terminal 2. To this end, the receiver 32 of the operator 3 is able to receive the address associated with the document from the fixed terminal 2. If the operator 3 knows the identity of the fixed terminal 2 in advance, which will not generally be the case, the sending step could be effected before the user enters the address on the man-machine interface 21 of the fixed terminal 2. The final step displays the document on the screen 20 of the fixed terminal 2. The document is sent and displayed in this way, but the message to which the document is linked may also be sent and displayed, the user then having access to the document via the message to which the document is linked.

Between the command step and the step of input by the user, there is preferably a step in which the sender 31 of the operator 3 sends the address associated with the document to the receiver 12 of the mobile terminal 1 so that the user will then know the address in order to be able to enter it via the man-machine interface 21 of the fixed terminal 2. This step is not necessary if the user already knows the address, for example because it is an address to which he habitually sends large documents attached to messages he receives. The step of the sender 31 of the operator 3 sending the document to the fixed terminal 2 is advantageously effected only after successful completion of a step of authentication of the mobile terminal 1 by the operator 3, to be more precise by the processor 33 of the operator 3.

In one embodiment, the address is always the same for the same mobile terminal 1 and is accompanied by a password. The password therefore ensures the security of the document. In another embodiment, the address is different for each message sent to the same mobile terminal 1 and is not accompanied by a password. In this case it is the different (for example random) character of the address that ensures the security of the document.

The document linked to the message sent to the mobile terminal 1 preferably includes a photo and/or a video. It may also be a network page, for example an Internet page, or any other type of document that it is difficult to display correctly on the screen of a mobile terminal. The user may make a choice as a function of the type of document; for example, he might choose to download and view directly on the screen of his mobile terminal a text document whose size is at most of the order of ten kilobytes, whereas he would request an address, for example a URL, for a photo (closer to a hundred kilobytes) or for a video (which could exceed one megabyte).

The mobile first terminal is preferably a mobile telephone or a personal digital assistant. The second terminal is advantageously a computer connected to the Internet. The second terminal preferably has a greater capacity than the mobile first terminal in terms of bandwidth and/or storage capacity and/or screen size. The greater the capacity difference, the greater the benefit to the user of transferring the document to the second terminal. In a preferred numerical example, the bandwidth of the mobile first terminal is of the order of one hundred kilobits whereas that of the second terminal may be from around ten to around a hundred megabits. The storage capacity of the mobile first terminal is preferably of the order of one hundred megabits whereas that of the second terminal is as high as one hundred gigabits or more. The screen size of the mobile second terminal is of the order of one thousand pixels in one direction by one thousand pixels in another direction; the screen size of the first terminal is often only a small fraction of the screen size of the second terminal, for example of the order of one tenth or even one hundredth thereof. Depending on the parameter type, the capacity of the second terminal is ten times, one hundred times or one thousand times greater than that of the mobile first terminal, for example. In addition to a greater capacity, the second, preferably fixed, terminal will often be more flexible and more user friendly than the mobile first terminal.

To prevent frauds consisting in a fraudster attempting to access on the second terminal the content of a document linked to a message for which said fraudster is not the addressee, the step of the operator sending the document to the second terminal is preferably effected only after successful completion of a step of authentication of the mobile first terminal by the operator. Another method associates addresses that, although simple, are sufficiently long to prevent fraud by brutal attack consisting in the fraudster systematically attempting all possible or plausible addresses. With a view to increasing security and limiting the liability of the operator, after the step of the operator sending the document to the second terminal, it is advantageous if it is no longer possible for the operator to send the document a third terminal, different from the first two. With a view to increasing security and limiting the liability of the operator, after the step of the operator sending the document to the second terminal, the document advantageously remains accessible on the second terminal for only a time, for example 24 hours, that is either predetermined or can be selected or modified by the user. After the user has consulted a document, he can destroy it to eliminate all trace of it in the second terminal. A form of fraud that nevertheless remains difficult to prevent is fraud on the part of the manager of the second terminal. Using secure socket layer (SSL) connections, which are the connections usually employed to connect fixed terminals to telecommunication networks, makes all kinds of fraud more difficult.

There is claimed:

1. A document access method comprising:
a step of an operator sending a mobile first terminal a message linked to a document;
a step of a user consulting the message on the screen of the mobile first terminal, showing a parameter representative of the size of the document;
a step of the user employing the man-machine interface of the mobile first terminal to command the operator to associate an address with the document;
a step of the user entering the address associated with the document via a man-machine interface of a second terminal having a greater capacity than the mobile first terminal;
a step of the operator sending at least the document to the second terminal; and
a step of displaying at least the document on the screen of the second terminal.

2. A document access method according to claim 1, including, between said command step and said step of entry by the user, a step of the operator sending the mobile first terminal the address associated with the document.

3. A document access method according to claim 1, wherein said mobile first terminal is a mobile telephone or a personal digital assistant and said second terminal is a computer connected to the Internet.

4. A document access method according to claim 1, wherein said second terminal has a greater capacity than said mobile first terminal in terms of bandwidth and/or storage capacity and/or screen size.

5. A document access method according to claim 1, wherein said document includes a photo and/or a video.

6. A document access method according to claim 1, wherein said address is always the same for the same mobile first terminal and is accompanied by a password.

7. A document access method according to claim 1, wherein said address is different for each message sent to the same mobile terminal and is not accompanied by a password.

8. A document access method according to claim 1, wherein said command step is effected simply by pressing a button or by clicking on an icon.

9. A document access method according to claim 1, wherein said step of said operator sending said document to said second terminal is effected only after successful completion of a step of authentication of said mobile first terminal by said operator.

10. A document access method according to claim 9, wherein it is not possible for said operator to send said document to a third terminal after said step of said operator sending said document to said second terminal.

11. A document access method according to claim 9, wherein said document remains accessible on said second terminal for only a predetermined time after said step of said operator sending said document to said second terminal.

12. A mobile terminal comprising:
a receiver adapted to receive from an operator a message linked to a document;
a man-machine interface adapted to receive input from a user;
a screen adapted to display a parameter representative of the size of said document at the command of said man-machine interface and after entry by a user; and
a sender adapted to send an operator a command to associate an address with said document following entry by said user at said man-machine interface.

13. A telecommunication operator comprising:
a sender adapted to send a mobile terminal a message linked to a document;
a receiver adapted to receive from a mobile terminal a command to associate an address with said document; and
a processor adapted to associate an address with said document; wherein:
said sender is adapted to send said address associated with said document to a mobile terminal;
said receiver is adapted to receive said address associated with said document from a terminal;
said sender is adapted to send at least said document to a terminal.
